(19) United States
(12) Patent Application Publication
(10) Pub. No.: US 2026/0017446 A1
(43) Pub. Date: Jan. 15, 2026

(54) SYSTEM FOR SUPPORTING SPECIFICATION PREPARATION

(71) Applicant: Semiconductor Energy Laboratory Co., Ltd., Atsugi-shi (JP)

(72) Inventors: Kengo AKIMOTO, Isehara (JP); Junpei MOMO, Sagamihara (JP)

(21) Appl. No.: 19/259,321

(22) Filed: Jul. 3, 2025

(30) Foreign Application Priority Data
Jul. 12, 2024 (JP) 2024-112566

(51) Int. Cl. G06F 40/166; G06F 40/40; G06Q 50/18

(52) U.S. Cl. CPC G06F 40/166; G06F 40/40; G06Q 50/184

(57) ABSTRACT

A system for supporting specification preparation having a function of receiving a summary of an invention, generating a first prompt including a content for preparing a first specification corresponding to the summary, obtaining the first specification from a language model as an answer to the first prompt, displaying the first specification, classifying the first specification into chapters, generating a second prompt including a content for obtaining data related to a first chapter that is classified from a second component and a content for creating a second chapter by revising the first chapter in accordance with the data, obtaining the second chapter as an answer to the second prompt from the language model, displaying the first chapter and the second chapter, comparing the first chapter and the second chapter to select the one which is suitable for the summary, and preparing a second specification including the selected chapter is provided.

### BACKGROUND OF THE INVENTION

### 1. Field of the Invention

The present invention relates to a system for supporting specification preparation utilizing a language model, typically a large language model (LLM).

The above technical field is one embodiment of the present invention, and the present invention is not limited to the above technical field. Examples of other embodiments of the present invention include a semiconductor device, a display device, a light-emitting device, a power storage device, a memory device, an electronic device, a lighting device, an input device (e.g., a touch sensor), an input/output device (e.g., a touch panel), driving methods thereof, and manufacturing methods thereof.

### 2. Description of the Related Art

Although techniques relating to the invention are well understood by an engineer, it is difficult to prepare a highly complete patent application specification (referred to as a specification in this specification and the like) with no practical experience. In view of the above, Patent Document 1 proposes a system for supporting specification preparation that allows an engineer unfamiliar with specifications to easily prepare specification documents.

In order to improve the answer accuracy of the LLM, a method called Retrieval-Augmented Generation (RAG) has attracted attention. In this method, related data is prepared as a database in advance, and when the user asks a question, data highly relevant to the question is searched from the database, and the obtained search result is added to the question sentence and input to the LLM; thus, an answer with high accuracy can be obtained. Non-Patent Document 1 discloses a mechanism relating to the RAG and shows that a language generation task enables language generation based on specific and various facts by the RAG.

### REFERENCES

### Patent Document

[Patent Document 1] Japanese Published Patent Application No. 2013-80279

### Non-Patent Document

[Non-Patent Document 1] Patrick Lewis et. al., “Retrieval-Augmented Generation for Knowledge-Intensive NLP Tasks”, 12 Apr. 2021.

### SUMMARY OF THE INVENTION

Generally, as items that a high-quality specification needs to be satisfied, ease of patent grant, ease of exercising right, a wide scope of claims, and the like are given. However, since there is no consideration on the above items in the system of Patent Document 1, there is room for improvement in preparing a high-quality specification. In addition, in Patent Document 1, a reduction in the time taken for preparing the specification has not been considered.

The present invention has been made in view of the above, and an object of one embodiment of the present invention is to provide a novel system for supporting specification preparation and an operation method thereof. Another object of one embodiment of the present invention is to provide a system for supporting specification preparation capable of obtaining a high-quality specification and an operation method thereof.

The present invention does not necessarily need to achieve all of these objects. The description of these objects does not disturb the existence of other objects of the present invention. Other objects can be derived from the description of the specification, the drawings, and the scope of claims, for example.

In view of the above objects, one embodiment of the present invention is a system for supporting specification preparation including a first component. The first component is configured to receive a summary of an invention, generate a first prompt for obtaining a first specification corresponding to the summary of the invention, obtain the first specification from a language model as an answer to the first prompt, display the first specification on an information terminal of a user, classify the first specification into chapters, generate a second prompt for obtaining data related to a classified first chapter from a second component and creating a second chapter by revising the first chapter in accordance with the data, obtain the second chapter as an answer to the second prompt from the language model, display the first chapter and the second chapter on the information terminal of the user, compare the first chapter and the second chapter to select the chapter which is suitable for the summary of the invention, and prepare a second specification including the selected chapter.

Another embodiment of the present invention is a system for supporting specification preparation including a first component. The first component is configured to receive a summary of an invention, generate a first prompt for obtaining a first specification corresponding to the summary of the invention, obtain the first specification from a language model as an answer to the first prompt, display the first specification on an information terminal of a user, classify the first specification into chapters, generate a second prompt for obtaining a plurality of pieces of information related to a classified first chapter from a second component, creating a second chapter by revising the first chapter in accordance with the plurality of pieces of information, and creating a third chapter in addition to the second chapter in accordance with the plurality of pieces of information, obtain the plurality of pieces of information, the second chapter, and the third chapter as an answer to the second prompt from the language model, display the plurality of pieces of information, the second chapter, and the third chapter on the information terminal of the user, compare the second chapter and the third chapter to select the chapter or the chapters suitable for the summary of the invention, and prepare a second specification including the selected chapter or the selected chapters.

In the system for supporting specification preparation in the present invention, in the case where the second chapter and the third chapter are deemed suitable for the summary of the invention, the first component is configured to generate a third prompt for obtaining a content describing a matter specifying an invention included in the second chapter as an independent claim of a third specification and a content describing a matter specifying an invention included in the third chapter as a dependent claim of the independent claim and describing the dependent claim while citing the independent claim, and the first component is configured to obtain the third specification from the language model as an answer to the third prompt.

Another embodiment of the present invention is a system for supporting specification preparation including a first component. The first component is configured to receive a summary of an invention and first experimental data, generate a first prompt for obtaining a first specification corresponding to the summary of the invention and describing the first experimental data in a first example of the first specification, obtain the first specification from a language model as an answer to the first prompt, display the first specification on an information terminal of a user, classify the first specification into chapters, generate a second prompt for obtaining information related to the first example from a second component and creating a second example by revising the first example in accordance with the first experimental data, obtain the second example as an answer to the second prompt from the language model, display the first example and the second example on the information terminal of the user, compare the first example and the second example to select the example suitable for the summary of the invention, and prepare a second specification including the selected example.

Another embodiment of the present invention is a system for supporting specification preparation including a first component. The first component is configured to receive a summary of an invention and first experimental data, generate a first prompt for obtaining a first specification corresponding to the summary of the invention and describing the first experimental data in a first example of the first specification, obtain the first specification from a language model as an answer to the first prompt, display the first specification on an information terminal of a user, classify the first specification into chapters, generate a second prompt for obtaining a plurality of pieces of information related to the first example from a second component, creating a second example by revising the first example in accordance with the plurality of pieces of information, and creating a third example in addition to the second example in accordance with the plurality of pieces of information, obtain the plurality of pieces of information, the second example, and the third example as an answer to the second prompt from the language model, display the plurality of pieces of information on the information terminal of the user, the second example, and the third example, compare the second example and the third example to select the example or the examples suitable for the summary of the invention, and prepare a second specification including the selected example.

In the system for supporting specification preparation in the present invention, in the case where the second example and the third example are deemed suitable for the summary of the invention are selected, the first component is configured to generate a third prompt for obtaining a content describing a matter specifying an invention included in the second example as an independent claim of a third specification and a content describing a matter specifying an invention included in the third example as a dependent claim of the independent claim and describing the dependent claim while citing the independent claim, and the first component is configured to obtain the third specification from the language model as an answer to the third prompt.

In the system for supporting specification preparation in the present invention, the summary of the invention includes a description of an object and a description of an effect.

According to one embodiment of the present invention, a novel system for supporting specification preparation and an operation method thereof can be provided. According to another embodiment of the present invention, a system for supporting specification preparation capable of obtaining a high-quality specification can be provided.

The present invention does not necessarily need to have all of these effects. The description of these effects does not disturb the existence of other effects of the present invention. Other effects can be derived from the description of the specification, the drawings, and the scope of claims, for example.

### BRIEF DESCRIPTION OF THE DRAWINGS

In the accompanying drawings:

FIGS. 1A and 1B illustrate examples of a screen of a system for supporting specification preparation of the present invention;

FIGS. 2A and 2B illustrate examples of the screen of the system for supporting specification preparation of the present invention;

FIGS. 3A and 3B illustrate examples of the screen of the system for supporting specification preparation of the present invention;

FIG. 4 illustrates an example of the system for supporting specification preparation of the present invention;

FIG. 5 illustrates an example of the system for supporting specification preparation of the present invention;

FIG. 6 illustrates an example of the system for supporting specification preparation of the present invention;

FIG. 7 is a flowchart showing an example of an operation method of the system for supporting specification preparation of the present invention;

FIG. 8 is a flowchart showing the example of the operation method of the system for supporting specification preparation of the present invention; and

FIG. 9 is a flowchart showing the example of the operation method of the system for supporting specification preparation of the present invention.

### DETAILED DESCRIPTION OF THE INVENTION

An embodiment of the present invention will be described with reference to the drawings. Note that it is easily understood by those skilled in the art that modes of the present invention can be changed in various ways without departing from the spirit of the present invention. Therefore, the present invention should not be construed as being limited to the description in the following embodiment.

The position, size, range, and the like of each component in the drawings and the like do not accurately represent those of the actual component in some cases. Thus, the position, size, range, and the like of each component are not necessarily limited to those disclosed in the drawings.

In this specification and the like, the terms “first” and “second” are sometimes used for easy understanding of the technical contents or identification of components. Thus, the terms “first” and “second” do not limit the number of components. In addition, the terms “first” and “second” do not limit the order of components. In addition, the terms such as “first” and “second” or identification numerals used in this specification do not correspond to the terms or the identification numerals in the scope of claims of this application in some cases.

In this specification and the like, a language model is a conversational (also referred to as interactive) model based on a transformer architecture and obtained by additional learning. In other words, a conversational generative model corresponds to a subordinate concept of the language model. The language model is also generally referred to as a large language model (LLM).

In this specification and the like, a document refers to a written representation of a person's intention with characters or symbols. The document includes in its category the state of being segmented into a plurality of chapters or a plurality of paragraphs. One chapter may be composed of a plurality of paragraphs.

### Embodiment

In this embodiment, an example of a system for supporting specification preparation will be described.

### <Screen of System for Supporting Specification Preparation and Screen Change>

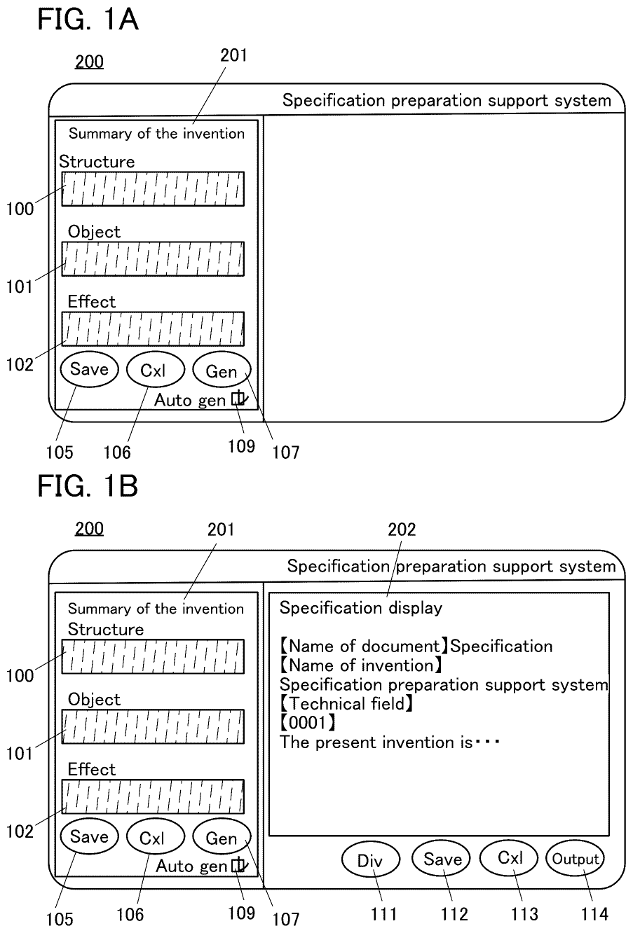

A screen for utilizing the system for supporting specification preparation and the screen change will be described with reference to FIGS. 1A and 1B, FIGS. 2A and 2B, and FIGS. 3A and 3B. FIGS. 1A and 1B, FIGS. 2A and 2B, and FIGS. 3A and 3B are examples of the screen displayed on a user's information terminal. Note that the change of the screen can be achieved by data processing of a first data processing device 10 or the like described later; however, the present invention is not limited thereto. The user is assumed to be an engineer who has proposed invention or a person in an intellectual property division of a company; however, the user is not limited thereto.

As illustrated in FIG. 1A, the user's information terminal displays a screen 200 on which conditions for receiving the specification preparation support are input. Since the specification preparation support system has a function of receiving the summary of the invention, the screen 200 preferably includes an input column 201 of the summary of the invention. The input column 201 of the summary of the invention includes a structure column 100, and a structure of the invention can be input to the structure column 100. The input column 201 of the summary of the invention includes an object column 101, and an object of the invention can be input to the object column 101. The input column 201 of the summary of the invention includes an effect column 102, and an effect of the invention can be input to the effect column 102. Since the object and effect are inseparable, inputting to either one of the columns is sufficient and inputting to the other is not necessarily performed.

Note that the above-described columns can be rephrased as input regions, and the positions of the columns on the screen 200 are not limited to those illustrated. The input column 201 of the summary of the invention may include another input column. Other examples of the input column include a column to which prior art documents are input, a column to which the name of the inventor is input, a column to which the drawings are input, and a column to which experimental data is input. It is particularly preferable that the specification preparation support system have a function of receiving experimental data (referred to as first experimental data for distinction), in which case an example based on the experimental data can be included in the specification. Note that the experimental data includes an experiment report.

As a method for inputting data to each column, one or both of a method for inputting characters to a text box and a method for uploading a file can be used. In the case where the file is uploaded and there is no text data in the file, the specification preparation support system preferably has a function of extracting text data from the file and storing the text data. Moreover, the specification preparation support system preferably has a function of preparing chunk data corresponding to each file. Note that the term “chunk data” refers to text data where portions related to each other in the document data are combined into one block.

A plurality of columns corresponding to the purpose are preferably prepared as in the screen 200 illustrated in FIG. 1A, in which case the user's input error can be reduced. Meanwhile, an inexperienced user might fill the column with a lack of understanding. Thus, it is also effective to provide an open-ended column without specifying an item instead of providing each column. The specification preparation support system may have a function of switching between displaying each column and displaying the open-ended column, depending on the user's skill.

The input column 201 of the summary of the invention includes a plurality of buttons for saving, canceling, generating, and the like. A save button 105 (Save) is a button for saving the input content, and a cancel button 106 (Cxl) is a button for canceling the input content. The save button 105 can be applied to any of the screens 200 described later. The cancel button 106 can also be applied to any of the screens 200 described later.

The specification preparation support system generates a prompt (sometimes referred to as a first prompt for distinction) including a content for preparing a specification (sometimes referred to as a first specification for distinction) corresponding to the summary of the invention with the use of data input to the input column 201 of the summary of the invention; thus, the screen 200 preferably includes a generation button 107 (Gen). When the user does not create the first prompt and the specification preparation support system has a function of creating the first prompt (referred to as automatic generation (Auto gen)), a highly accurate answer can be obtained regardless of the user's skill. Note that the function of automatically generating the first prompt includes a function of editing an existing prompt (a past prompt used in the system) by the specification preparation support system in accordance with the summary of the invention input by the user. Whether or not automatic generation is performed is preferably determined by the user with the use of a check box 109 provided in a position adjacent to the generation button 107.

The specification preparation support system may include, in the first prompt, a content of describing the first experimental data in an example of the first specification (referred to as a first example for distinction). By the first prompt, the first specification can include the first example based on the first experimental data.

Such a specification preparation support system enables, even the user unfamiliar with the language model processing, to obtain a highly accurate answer. Note that in the specification preparation support system, the user may create the first prompt; when the automatic generation check box is unchecked and the generation button 107 is pressed, a column for inputting the first prompt by the user is preferably displayed on the screen 200.

Furthermore, in order to obtain the first specification from the language model as an answer of the first prompt, the specification preparation support system preferably executes the following series of processing when the generation button 107 is pressed: the first prompt is automatically created based on the summary of the invention input by the user, the first prompt is supplied to the language model, and then the first specification is obtained from the language model as an answer. The generation button 107 can be applied to any of the screens 200 described later.

As the language model used for the specification preparation support system, Bidirectional Encoder Representations from Transformers (BERT) or Text-to-Text Transfer Transformer (T5) can be used. In the case where LLM is used as the language model, GPT-3 (registered trademark), GPT-3.5, GPT-4 (registered trademark), Language Model for Dialogue Applications (LaMDA), Pathways Language Model (PaLM), Llama2, Llama 3, or the like can be used for the LLM.

In the LLM, there is an appropriate value of each of the number of input tokens and the number of output tokens due to learning processes, algorithm, or hardware limitations. In this specification and the like, the number of input tokens and the number of output tokens are collectively referred to as the number of tokens that the LLM can process at a time. An appropriate number of tokens may be set in the specification preparation support system. For example, the number of output tokens may be specified for a prompt used in the specification preparation support system.

A plurality of input columns and a plurality of buttons are preferably prepared as illustrated in FIG. 1A, in which case the user's input error and operation error can be reduced.

### <Screen Change 1>

When the generation button 107 of the input column 201 of the summary of the invention is pressed, the screen 200 in FIG. 1A changes to the screen 200 in FIG. 1B. Since the specification preparation support system that obtains the first specification from the language model has a function of displaying the first specification, the screen 200 preferably includes a specification display column 202. Specifically, as illustrated in FIG. 1B, the first specification, which is an answer from the language model, is displayed on the specification display column 202 so that the user can check the first specification. Note that in the first specification, contents other than the data input to the input column 201 of the summary of the invention are within the range where the language model has learned in advance. At this time, the screen 200 preferably displays the input column 201 of the summary of the invention and the specification display column 202 so that they do not overlap with each other. When checking the first specification in the specification display column 202, the user can check whether the input content of the input column 201 of the summary of the invention is appropriate. Furthermore, the user can check the first example included in the first specification.

In the case where a document related to the first specification is outside the specification display column 202, the specification display column 202 preferably includes a scroll bar. The scroll bar can be used in any of columns described later.

The specification preparation support system has a function of classifying the first specification into an appropriate range. Specifically, the screen 200 preferably includes a division button 111 (Div) so that the first specification is classified into chapters. At least one of the classified chapters is referred to as a first chapter. Typically, the specification preparation support system classifies the first specification in accordance with an embodiment or an example. The embodiment and the example are examples of chapters that are easy to differentiate technically and preferable as classified chapters. Although the first specification is not necessarily divided in accordance with the embodiment or the example, the first specification is preferably classified such that the document is technically coherent.

In the specification preparation support system, in consideration of the limitation of the number of tokens of the language model, the upper limit of the number of characters of the first chapter can be set. In the case where the number of characters of the first chapter exceeds the set value, the specification preparation support system can further classify the first chapter into new chapters by pressing the division button 111 again.

As the other buttons, the screen 200 preferably includes a save button 112 (Save), a cancel button 113 (Cxl), an output button 114 (Output), and the like. Since the description of the buttons already mentioned can be referred to for FIG. 1A, the description of the save button 112 and the cancel button 113 is omitted. The output button 114 is a button for outputting a document displayed on the specification display column 202. There is no limitation on the format of the output file.

### <Screen Change 2>

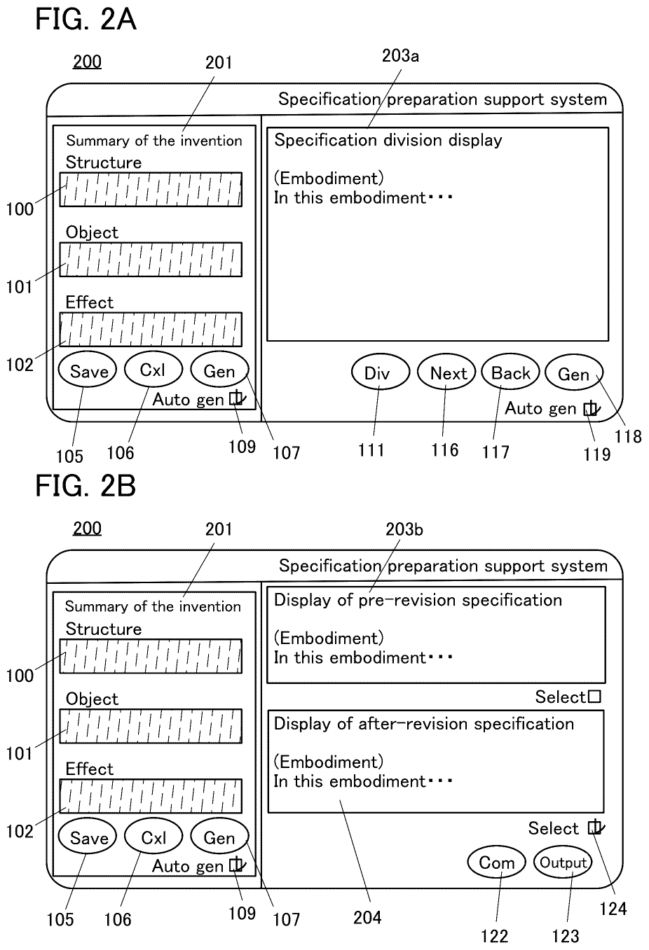

When the division button 111 is pressed, the screen 200 in FIG. 1B changes to the screen 200 in FIG. 2A. Specifically, as illustrated in FIG. 2A, the specification display column 202 is replaced with a specification division display column 203a, and the first chapter is displayed. At this time, the screen 200 preferably displays the input column 201 of the summary of the invention and the specification division display column 203a so that they do not overlap with each other. When checking the first chapter in the specification division display column 203a, the user can check whether the input content of the input column 201 of the summary of the invention is appropriate.

The specification division display column 203a preferably includes the division button 111, a next button 116 (Next), a back button 117 (Back), a generation button 118 (Gen), a check box 119 for automatic generation, and the like. Since FIGS. 1A and 1B can be referred to for the buttons already mentioned, the description of the division button 111, the generation button 118, and the check box 119 is omitted. In the case where there are a plurality of chapters displayed on the specification division display column 203a, the next button 116 in FIG. 2A is a button for sequentially sending the chapters, and the back button 117 in FIG. 2A is a button for sequentially returning the chapters. Instead of or in addition to the next button 116 and the back button 117, a button for displaying a plurality of chapters in a list may be included.

The specification preparation support system has a function of generating a prompt (referred to as a second prompt for distinction) including a content of obtaining data related to the first chapter from a database and a content of creating a new chapter (a chapter being revised is referred to as a second chapter for distinction) by revising the first chapter in accordance with the data; thus, the screen 200 preferably includes the generation button 118. Typically, the specification division display column 203a preferably includes the generation button 118. When the user does not create the second prompt and the specification preparation support system has a function of automatically creating the second prompt, a highly accurate answer can be obtained regardless of the user's skill. Note that the function of automatically generating the second prompt includes a function of editing an existing prompt (a past prompt used in the system) by the specification preparation support system in accordance with the summary of the invention input by the user. Whether or not automatic generation is performed is preferably determined by the user with the use of the check box 109 provided in a position adjacent to the generation button 107.

Furthermore, the specification preparation support system can include, in the second prompt, a content of obtaining data related to the first example from the database. Whether or not the second prompt is automatically generated is preferably determined by the user.

Such a specification preparation support system enables, even the user unfamiliar with the language model processing, to obtain highly accurate answer. Note that in the specification preparation support system, the user may create the second prompt; when the automatic generation check box is unchecked and the generation button 107 is pressed, a column for inputting the second prompt by the user is preferably displayed on the screen 200.

Furthermore, in order to obtain the second chapter from the language model as an answer of the second prompt, the specification preparation support system preferably executes the following series of processing when the generation button 107 is pressed: the second prompt is automatically created based on the first chapter, the second prompt is supplied to the language model, and then the second chapter is obtained from the language model as an answer. The generation button 107 is regarded to have a function similar to that of the generation button 107 described for the first prompt.

Furthermore, the specification preparation support system can obtain a second example by revising the first example on the basis of the data. In the case where there are a plurality of pieces of data, the specification preparation support system can obtain a third example in addition to the second example.

The data related to the first chapter preferably includes data of a company that the user belongs to, in which case the specification preparation support system can perform a similarity search on a database of the company to obtain the data. As the similarity search, it is preferable to perform a search for a keyword included in the first chapter or a search for a phrase included in the first chapter. In a keyword search, characters are decomposed before and after a blank space and then collected. In a phrase search, characters including a blank space are collected. In such a keyword search and a phrase search, results can be obtained with a small load in a short time. The specification preparation support system can perform a vector search as another mode of the similarity search. A vector search is performed in such a manner that data including text, an image, and the like is converted into a numerical vector and then similarity between the vectors is calculated. A vector search can be performed at higher speed than a keyword search, and results with higher relevance can be obtained. In other words, a vector search is preferable because a result close to the result that the user intended can be obtained even when a common word cannot be specified.

The specification preparation support system can extract data from the database of the company utilizing the language model. For example, when a prompt based on similarity search data is supplied to the language model, the specification preparation support system can obtain the data. A RAG method is preferably used for the similarity search.

The specification preparation support system preferably determines whether or not the data is related to the first chapter. For the determination, a sentence is converted into a distributed representation and similarity of values based on the distributed representation can be used. In this case, the specification preparation support system preferably has a function of converting the first chapter into the distributed representation of the sentence. Furthermore, data converted into the distributed representation of the sentence is preferably added to data saved in the database. Note that for the distributed representation of the sentence, doc2vec, Sentence BERT, Universal Sentence Encoder, BERTScore, or the like can be used, for example. Furthermore, distributed representation can be rephrased as embedded representation. It is also possible to create a distributed representation of a sentence from the average of distributed representations of the words of the sentence, for example.

The similarity in distributed representation is calculated using cosine similarity, covariance, unbiased covariance, or Pearson product-moment correlation coefficient, for example. Among them, especially cosine similarity is preferably used.

The pre-revision first chapter often includes a large number of general contents with no originality; however, the second chapter that is revised using data of the company that the user belongs to can include a large number of original contents. The data with originality is preferable because novelty may be ensured.

Moreover, the data saved in the database of the company can include data on a specification that is easily patented. Thus, a specification obtained from the specification preparation support system is more easily patented. Furthermore, the data saved in the database of the company can include data on a specification that is easily exercised. Thus, the specification obtained from the specification preparation support system is more easily exercised. Furthermore, the data saved in the database of the company can include data on a specification with a wide scope of claims. Thus, the specification obtained from the specification preparation support system has a wide scope of claims. Note that without limitation to the database of the company, a public database owned by the Patent Office or a public database owned by court may be used. For example, database saved in a publication of patent application, a patent publication, a book, or a document may be used as the data.

In this manner, the database can include a variety of data. Thus, the user preferably selects the database. When the specification preparation support system is utilized after the database is selected, appropriate data can be obtained in a short time.

### <Screen Change 3>

When the generation button 118 is pressed, the screen 200 in FIG. 2A changes to the screen 200 in FIG. 2B. Specifically, as illustrated in FIG. 2B, the name of the specification division display column 203a is changed to a pre-revision specification display column 203b, and an after-revision specification display column 204 is displayed on the screen 200. At this time, the screen 200 preferably displays the pre-revision specification display column 203b and the after-revision specification display column 204 so that they do not overlap with each other. The user can compare the first chapter of the pre-revision specification display column 203b and the second chapter of the after-revision specification display column 204 to select one or both suitable for the summary of the invention. For this selection, the screen 200 preferably includes a selection box 124.

As illustrated in FIG. 2B, the screen 200 includes a combination button 122 (Com) and an output button 123 (Output). Since FIGS. 1A and 1B and FIG. 2A can be referred to for the buttons already mentioned, the description of the output button 123 is omitted. With the combination button 122, a new specification (referred to as a second specification for distinction) can be prepared by combining selected chapters, and the second specification including the selected chapters can be proposed to the user by the specification preparation support system.

### <Screen Change 4>

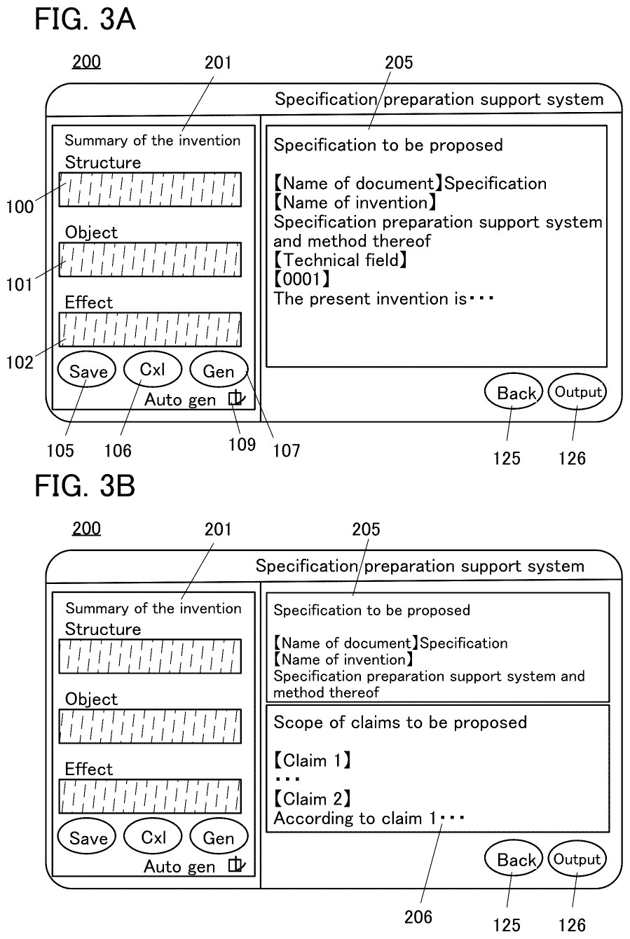

When the combination button 122 is pressed, the screen 200 in FIG. 2B changes to the screen 200 in FIG. 3A. Specifically, the second specification can be displayed on a specification column 205 to be proposed as illustrated in FIG. 3A. An output button 126 (Output) can be pressed when the proposed specification has no problem, and a back button 125 (Back) can be pressed when the proposed specification has a problem or the operation is restarted. In particular, in the case where experimental data is received in addition to the summary of the invention, an example described with the experimental data can be included in the second specification, which is preferable.

### <Screen Change 5>

Unlike in FIG. 3A, in FIG. 3B, when the combination button 122 is pressed, the screen 200 includes a column of the scope of claims 206 to be proposed in addition to the specification column 205 to be proposed. The user can press the output button 126 as long as the second specification and the scope of claims have no problems, and can press the back button 125 when the second specification and the scope of claims have a problem or the operation is restarted. In particular, in the case where experimental data is received in addition to the summary of the invention, an example described with the experimental data can be included in the second specification and a matter specifying the invention of the example can be described in the scope of claims, which are preferable.

With such a specification preparation support system, even an inexperienced engineer can prepare a high-quality specification. Furthermore, the time required for the specification preparation can be shortened.

The specification preparation support system is preferably used by a person in an intellectual property division who has practical experience, which allows obtaining the specification that is more easily patented, the specification that is more easily exercised, and the specification with a wide scope of claims can be obtained. Furthermore, a fatal mistake in the specification preparation can be reduced.

### Structure Example 1 of System for Enjoying Service of Specification Preparation Support System

A system for enjoying a service of the specification preparation support system includes the first data processing device 10, a second data processing device 40, a third data processing device 50, and an information terminal 20. The first data processing device 10, the second data processing device 40, and the information terminal 20 can each be referred to as a component. The first data processing device 10 is a component that enables execution of the specification preparation support system, the second data processing device 40 is a component that enables execution of the language model, and the information terminal 20 is a component used by the user. The information terminal 20 can also be a component that enables execution of the specification preparation support system. The third data processing device 50 is a database that enables RAG. The RAG may be executed in a database provided in the first data processing device 10 or a database provided in the information terminal 20.

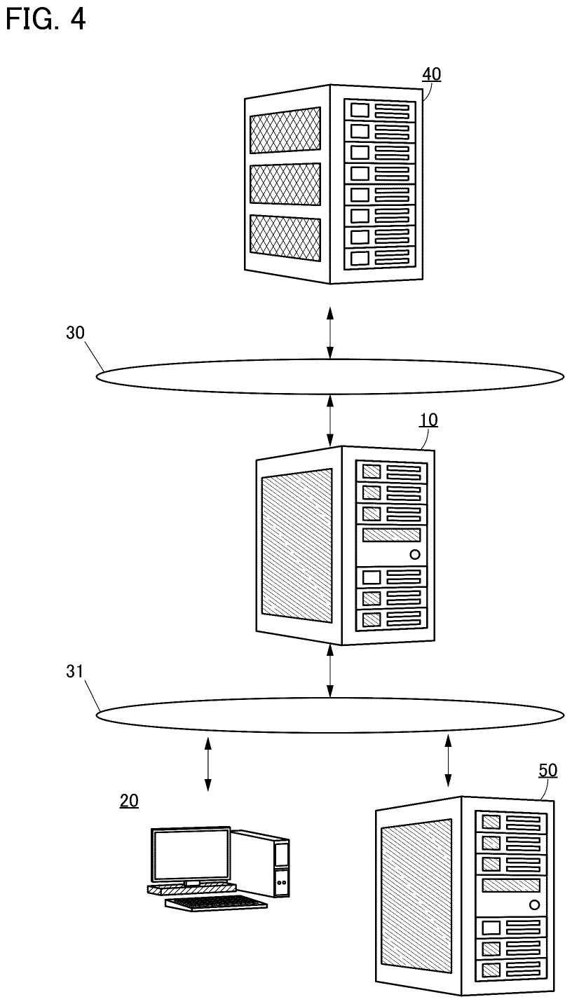

The information terminal 20 is connected to the first data processing device 10 via a network 31 as illustrated in FIG. 4. The first data processing device 10 is connected to the third data processing device 50 through the network 31. The first data processing device 10 is connected to the second data processing device 40 through a network 30.

### Structure Example 2 of System for Enjoying Service of Specification Preparation Support System

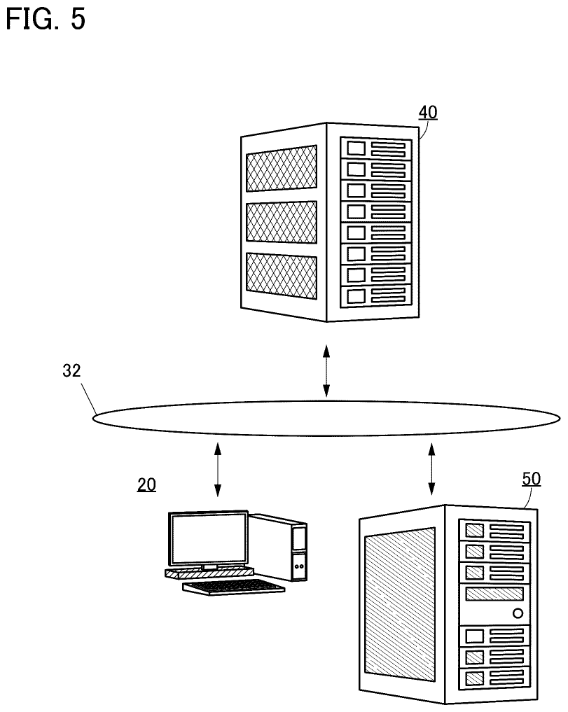

As illustrated in FIG. 5, a system for enjoying the service of the specification preparation support system includes the second data processing device 40, the third data processing device 50, and the information terminal 20 without including the first data processing device 10 in some cases. Although the first data processing device 10 is not used, the second data processing device 40 is a system for enjoying a service having a function of the first data processing device 10. That is, the second data processing device 40 is a component that enables execution of the specification preparation support system and a language model, the third data processing device 50 is a component that enables RAG, and the information terminal 20 is a component used by the user.

As illustrated in FIG. 5, the second data processing device 40 is connected to the information terminal 20 and the third data processing device 50 via a network 32.

### Structure Example 3 of System for Enjoying Service of Specification Preparation Support System

Although not illustrated, the information terminal 20 may have a function of the first data processing device 10 as a system for enjoying the service of the specification preparation support system. In this case, the system for enjoying the service of the specification preparation support system includes the second data processing device 40, the third data processing device 50, and the information terminal 20.

### Example of Data Processing Device (Hardware) that Enables Specification Preparation Support System to be Executed

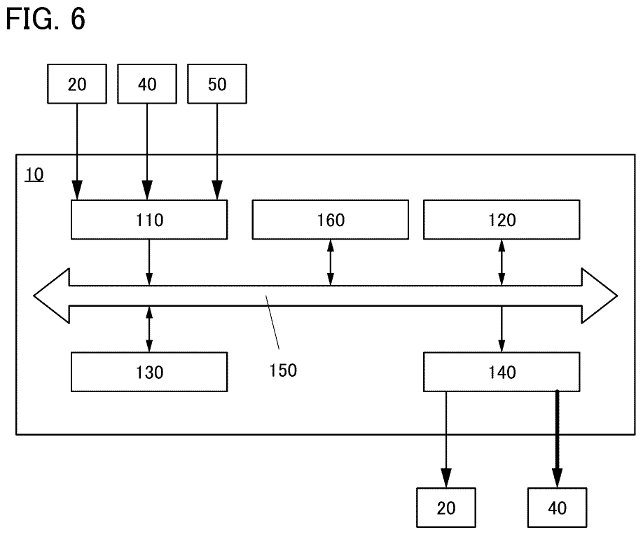

An example of the first data processing device 10 (sometimes referred to as a first component) that enables the specification preparation support system to be executed will be described with reference to FIG. 6. FIG. 6 illustrates the information terminal 20, the second data processing device 40, and the third data processing device 50 in addition to the first data processing device 10, and arrows indicate data transmission and reception. The first data processing device 10 includes an input portion 110, a memory portion 120, a processing portion 130, an output portion 140, a transmission path 150, and a display 160. In the case where a content is displayed only by the information terminal 20, the display in the first data processing device 10 is unnecessary.

### [Input Portion 110]

The input portion 110 can have a function of receiving data from the outside. For example, the input portion 110 has a function of receiving the summary of the invention from the information terminal 20. Typically, the input portion 110 has a function of receiving the summary of the invention input to the input column 201 of the summary of the invention illustrated in FIG. 1A by the user.

Moreover, the input portion 110 can also receive data from the second data processing device 40. Since the second data processing device 40 is a component that enables execution of the language model, an example of data to be received is an answer sentence. Furthermore, since the input portion 110 can receive data from the third data processing device 50 and the third data processing device 50 is a database that enables RAG, an example of data to be received is data related to a question sentence.

The input portion 110 can supply the received data to one or more selected from the memory portion 120, the processing portion 130, and the display 160 through the transmission path 150.

### [Memory Portion 120]

The memory portion 120 can store a program and/or data, for example. A typical example of the program is a program that executes the specification preparation support system. The data includes the data received by the input portion 110. The data may include data generated by the processing portion 130 (e.g., an arithmetic result, an analysis result, or an inference result). As the data of the memory portion 120, a fixed phrase of a prompt can be saved. It is also possible to save what the user has written as the fixed phrase. It is preferable to save prompts previously used in the specification preparation support system. Furthermore, the memory portion 120 can be used as a database for RAG. In this case, the third data processing device 50 can be omitted from the system for enjoying the service of the specification preparation support system.

The memory portion 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase-change random access memory (PRAM), a ferroelectric random access memory (FeRAM), a magnetoresistive random access memory (MRAM, also referred to as a magnetoresistive memory), and a flash memory. The memory portion 120 can include a Si LSI (a circuit including silicon transistors).

The memory portion 120 may include at least one of a NOSRAM (registered trademark) and a DOSRAM (registered trademark). The memory portion 120 may include a recording media drive. Examples of the recording media drive include a hard disk drive (HDD) and a solid state drive (SSD).

Note that the NOSRAM is an abbreviation for “nonvolatile oxide semiconductor random access memory (RAM)”. The NOSRAM includes a two-transistor (2T) or three-transistor (3T) gain memory cell and refers to a memory including transistors whose channel formation regions are formed using a metal oxide (also referred to as OS transistors). The OS transistor has an extremely low current that flows between a source and a drain in an off state, that is, an extremely low leakage current. The NOSRAM can be used as a nonvolatile memory by retaining electric charge corresponding to data in memory cells, using characteristics of extremely low leakage current. In particular, the NOSRAM is capable of reading retained data without destruction (non-destructive reading), and thus is suitable for arithmetic processing in which only a data reading operation is repeated many times. NOSRAM memory cells can be stacked. The stack of NOSRAM memory cells enables an increase in data capacity and thus enables an improvement in performance when used as a large-scale cache memory, a large-scale main memory, or a large-scale storage memory.

The DOSRAM is an abbreviation for a dynamic oxide semiconductor RAM and refers to a RAM including a one-transistor (IT) and one-capacitor (1C) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide contained in the channel formation region preferably contains indium (In). An OS transistor formed using a metal oxide containing indium in its channel formation region has a high carrier mobility (electron mobility). The metal oxide contained in the channel formation region is preferably an oxide semiconductor containing an element M described later instead of or in addition to In. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. The metal oxide may contain a combination of a plurality of the elements listed as the element M. The element M is an element having a high bonding energy with oxygen, and its bonding energy with oxygen is higher than the bonding energy of indium with oxygen. The metal oxide contained in the channel formation region is preferably a metal oxide containing zinc (Zn) instead of or in addition to In. The metal oxide containing zinc is easily crystallized in some cases.

The metal oxide contained in the channel formation region is not limited to the metal oxide containing the above element, typically, indium. The metal oxide in the channel formation region may be, for example, a metal oxide that does not contain indium but contains any of zinc, gallium, and tin (e.g., zinc tin oxide and gallium tin oxide).

### [Processing Portion 130]

Typically, the processing portion 130 has a function of automatically generating a prompt. Specifically, the processing portion 130 preferably has a function of selecting a given prompt saved in the memory portion 120 and generating a prompt in accordance with the content of the input portion 110. Data generated by the processing portion 130 (e.g., a prompt) can be supplied to one or both of the memory portion 120 and the output portion 140. For example, the data can be supplied to the memory portion 120 through the transmission path 150. Furthermore, the function of automatically generating the prompt in the processing portion 130 preferably has a function of supplying the prompt to the language model and obtaining an answer. The processing portion 130 can supply obtained data (e.g., an answer sentence) to one or both of the memory portion 120 and the output portion 140. For example, the data can be supplied to the output portion 140 through the transmission path 150.

In addition to the function of automatically generating a prompt, the processing portion 130 preferably has a function of executing processing related to the buttons described with reference to FIGS. 1A and 1B and FIGS. 2A and 2B. When each button is clicked (pressed), the processing portion 130 can execute processing related to the button.

Furthermore, the processing portion 130 preferably has a function of determining whether the answer was obtained or not. The user can check the obtained answer to determine whether the user has been able to obtain the answer.

The processing portion 130 also preferably has a function of producing display data. The processing portion 130 preferably produces display data having an easy-to-see layout on the display 160 for the user. The processing portion 130 preferably has a function of producing display data of the user's information terminal 20 instead of or in addition to the display 160. The display data of the display 160 and the display data of the user's information terminal 20 are preferably the same data, in which case the load on the processing portion 130 is reduced. Needless to say, the processing portion 130 can produce data different between the display 160 and the information terminal 20.

The processing portion 130 includes at least an arithmetic circuit. For example, a central processing unit (CPU) can be included as the arithmetic circuit. The CPU includes an arithmetic unit, a primary cache memory, a secondary cache memory, and the like. The processing portion 130 may include a graphics processing unit (GPU) in addition to or instead of a CPU. The GPU includes an arithmetic unit, a primary cache memory, a secondary cache memory, and the like. A switch or the like included in the CPU or the GPU can include one or both of an OS transistor (a transistor using an oxide semiconductor layer for a channel) and a Si transistor (a transistor using a semiconductor layer containing silicon for a channel).

The processing portion 130 may include a register and a main memory in addition to the CPU. The register and the main memory are sometimes included in the CPU. The main memory can transmit and receive data to and from the secondary cache or the like. The main memory includes at least one of a volatile memory such as a random access memory (RAM) and a nonvolatile memory such as a read only memory (ROM). The main memory may include at least one of a NOSRAM and a DOSRAM. The main memory can include one or both of an OS transistor and a Si transistor. Note that when the CPU in this paragraph is replaced with the GPU, the structures of the register and the main memory can be understood.

Examples of the RAM include a DRAM and an SRAM. In a DRAM or an SRAM, a virtual memory space can be assigned and utilized as a working space of the processing portion 130. An operating system, an application program, a program module, program data, a look-up table, and the like which are stored in the memory portion 120 are loaded into the RAM immediately before execution. The operating system, the application program, the program module, the program data, and the look-up table which are loaded into the RAM can be accessed from the processing portion 130.

A system that does not require rewriting or the like can be stored in the ROM. As the system that does not require rewriting, a basic input/output system (BIOS) and firmware can be given, for example. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing portion 130 may include a microprocessor such as a digital signal processor (DSP) in addition to the CPU or the GPU. The DSP is specialized in digital signal processing and is thus preferably included to control a peripheral circuit and the like of the CPU or the GPU. The microprocessor may be configured with a programmable logic device (PLD), which is operated by hardware, such as a field programmable gate array (FPGA) or a field programmable analog array (FPAA). The processing portion 130 may include a quantum processor. The processing portion 130 can interpret instructions from various kinds of programs with use of a processor such as the quantum processor and execute various kinds of data processing and program control. The programs to be executed by the processor are stored in at least one of the memory portion 120 and a memory region of the processor.

The OS transistor has an extremely low off-state current; therefore, with the use of the OS transistor as a switch for retaining electric charge (data) that has flowed into a capacitor, a long data retention period can be ensured. When at least one of a register and a cache memory included in the processing portion 130 has such a feature, the processing portion 130 can be operated only when needed, and otherwise can be supplied with no signal and electric power while data processed immediately before turning off the processing portion 130 is stored in the memory element. In other words, the OS transistor enables normally-off computing and reduces the power consumption of the specification preparation support system.

When a CPU or the like capable of high-speed operation is used in the processing portion 130, artificial intelligence (AI) can be used for part of processing executed by the first data processing device 10. The first data processing device 10 preferably includes an artificial neural network (ANN, hereinafter also simply referred to as a neural network) to enable processing using AI. Since the neural network can be implemented by a circuit (hardware) or a program (software), the first data processing device 10 preferably includes the circuit or the program in addition to the CPU capable of high-speed operation.

In this specification and the like, the neural network indicates a general model having the capability of solving problems, which is modeled on a biological neural network and determines the connection strength of neurons by learning. The neural network includes an input layer to which data is input, an output layer from which data is output, and an intermediate layer (a hidden layer) between the input layer and the output layer, and a weight for input data is optimized in order to obtain a correct output result.

In the description of the neural network in this specification and the like, to determine a weight coefficient between neurons from the existing data is referred to as “learning” in some cases.

In this specification and the like, to draw a new conclusion from a neural network formed with a weight coefficient obtained by learning is referred to as “inference” in some cases.

### [Output Portion 140]

The output portion 140 has a function of outputting data (e.g., an arithmetic result or the like of the processing portion 130) to the outside. An example of the outside is one or more selected from the second data processing device 40 and the information terminal 20. For example, the user can check an answer sentence output from the output portion 140 to the information terminal 20.

### [Transmission Path 150]

The transmission path 150 has a function of transmitting data. Data transmission and reception among the input portion 110, the memory portion 120, the processing portion 130, the output portion 140, and the display 160 can be performed through the transmission path 150.

### Structure Example of Second Data Processing Device

Next, a structure example of the second data processing device 40 is described. The second data processing device 40 can perform processing using a language model. For example, processing using a natural language processing model such as BERT or T5 can be executed. The second data processing device 40 can execute processing using a general-purpose language processing model capable of performing a variety of natural language processing tasks.

The second data processing device 40 can also perform processing using a model (e.g., a document generation model or an interaction model) utilizing LLM. For example, GPT-3, GPT-3.5, GPT-4, LaMDA, PaLM, Llama2, Llama3, or the like can be used as the LLM. Needless to say, a model constructed in the company can be used as the LLM.

The second data processing device 40 can perform processing such as arithmetic operation using data received from the first data processing device 10. Accordingly, the load of arithmetic operation on the first data processing device 10 can be reduced.

A specification preparation support system provider does not necessarily have its own second data processing device 40. For example, a service provider can utilize part of a service provided by another service provider or the like using the second data processing device 40.

### Structure Example of Information Terminal 20

The information terminal 20 is operated by the user and is a device capable of inputting data of FIGS. 1A and 1B and FIGS. 2A and 2B. For input, the information terminal 20 includes an input device such as a keyboard and a speaking device such as a microphone. The information terminal 20 can also be referred to as a client computer or the like. The information terminal 20 preferably operates dedicated application software, a web browser, or the like. Thus, the user can enjoy a service using the specification preparation support system.

Although a desktop computer is illustrated as an example in FIGS. 4 and 5, a laptop computer, a smartphone, or a tablet computer may be used as the information terminal 20. In the tablet computer, a housing including an input portion (typically, a keyboard) can be folded back to overlap with a main body. In addition, there is a tablet computer that can separate a housing from a main body. A laptop computer, a smartphone, or a tablet computer is easy to carry, and thus is suitable in the case where the user uses the specification preparation support system of one embodiment of the present invention at visiting places.

The information terminal 20 can provide data output from the specification preparation support system or LLM to the user. That is, in the specification preparation support system, it is preferable that the user operate the information terminal 20 and not operate the first data processing device 10 and the second data processing device 40. This structure can improve the security.

In the case where a service provider using the specification preparation support system and the user who enjoys the service belong to the same organization such as a company, data transmission and reception between the information terminal 20 and the first data processing device 10 is preferably performed using the network 31 constructed in the organization, for example. Thus, data can be transmitted and received between the information terminal 20 and the second data processing device 40 more safely than in the case where data is transmitted and received via the Internet. Furthermore, internal data can be prevented from leaking to the outside of the company. Alternatively, data transmission and reception between the information terminal 20 and the first data processing device 10 may be performed using the network 30 (e.g., the Internet).

### <<Network 30>>

The network 30 connects the first data processing device 10 and the second data processing device 40 to each other. Thus, input data and processed data can be transmitted and received between the first data processing device 10 and the second data processing device 40. Furthermore, loads of the data processing can be dispersed.

Note that the case where the network 30 is a larger computer network than the network 31 is mainly described in this embodiment. For example, a global network can be used as the network 30. Specifically, the Internet, which is an infrastructure of the World Wide Web (WWW), can be used.

### <<Network 31>>

The network 31 connects the information terminal 20 and the first data processing device 10 to each other. Thus, data can be transmitted and received between the information terminal 20 and the data processing device 10. Furthermore, loads of the data processing can be dispersed. Furthermore, the service provider can provide a service using the specification preparation support system to the user through the network 31, for example.

For example, a local network can be used as the network 31. An intranet or an extranet can be used as the network 31. A personal area network (PAN), a local area network (LAN), a campus area network (CAN), a metropolitan area network (MAN), a wide area network (WAN), a global area network (GAN), or the like can be used as the network 31.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

### <<Network 32>>

The second data processing device 40 is connected to the information terminal 20 and the third data processing device 50 via the network 32. Thus, input data and processed data can be transmitted and received between the information terminal 20 and the second data processing device 40. Furthermore, loads of the data processing can be dispersed. As the network 32, the network 30 or the network 31 described above can be used.

According to one embodiment of the present invention, a novel operation method of a specification preparation support system can be provided. According to another embodiment of the present invention, a method for operating a specification preparation support system using a language model, in which the number of tokens is less than or equal to that set in the language model, can be provided.

Next, an example of an operation method of the specification preparation support system of one embodiment of the present invention is described with reference to a flowchart.

### Operation Method Example 1 of Specification Preparation Support System

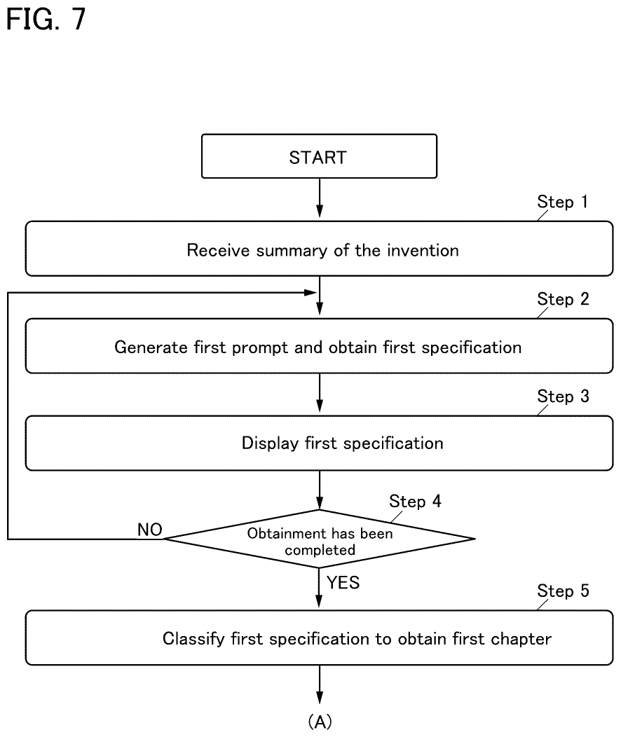

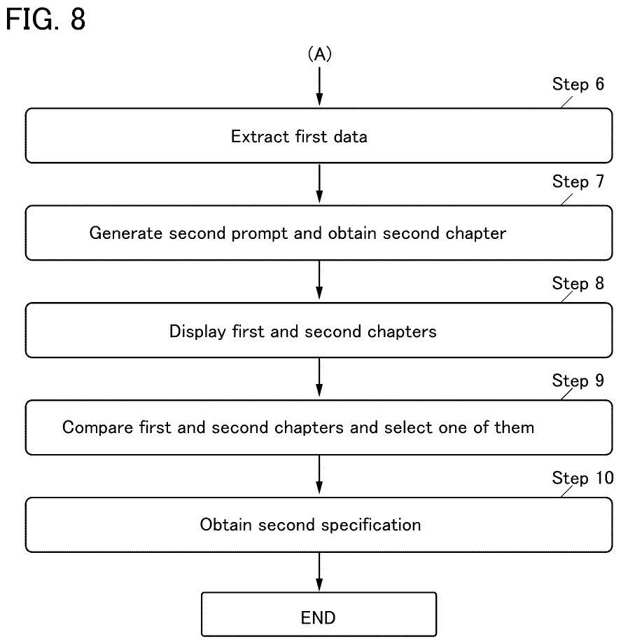

In the specification preparation support system, a method for preparing a specification and the like is described. An example of the method includes Step 1 to Step 10 as illustrated in FIGS. 7 and 8. Step 1 to Step 5 are described with reference to FIG. 7, and Step 6 to Step 10 are described with reference to FIG. 8. Note that (A) after Step 5 in FIG. 7 means that the operation continues to (A) shown in FIG. 8.

### Step 1: Reception of Summary of Invention

In this step, the specification preparation support system receives the summary of the invention. Typically, the specification preparation support system receives the summary of the invention input to the input column 201 of the summary of the invention illustrated in FIG. 1A by the user. The summary of the invention is preferably written in a natural language, and the user can describe the summary of the invention in a language selected from English, Japanese, and other languages. There is no limitation on the language of the summary of the invention, and two or more of the above-described languages may be used in combination.

### Step 2: Generation of First Prompt and Obtainment of First Specification

In this step, the specification preparation support system generates a first prompt including a content of preparing a first specification corresponding to the summary of the invention. Typically, the prompt is generated in the processing portion 130 or the like illustrated in FIG. 6. It is preferable that the prompt be automatically generated in the processing portion 130 as described above. Needless to say, the prompt can be created by the user without being automatically generated. As illustrated, this step in the case where the prompt is automatically generated includes the step of generating the first prompt to the step of obtaining the first specification. In the case where the prompt is not automatically generated, a step including the reception of the first prompt and a step including the obtainment of the first specification are performed instead of Step 2.

### Step 3: Display of First Specification

In this step, the specification preparation support system displays the first specification. Typically, the first specification is displayed on the specification display column 202 illustrated in FIG. 1B. The user can check the first specification. Note that the first specification is within the range where the language model or the like has learned.

### Step 4

In this step, the specification preparation support system determines whether the first specification is appropriate. An appropriate specification refers to a specification that satisfies document requirements of the specification. Furthermore, the user can set an appropriate condition of the specification. For example, under the condition where the specification includes an example, the user can judge whether or not the condition is satisfied. In the case where the specification is determined to be appropriate, the specification preparation support system determines that the obtainment has been completed (YES) and proceeds to Step 5. In the case where the specification is determined to be inappropriate, the specification preparation support system determines that the obtainment is in completed (NO), returns to Step 2, and performs Step 2 to Step 4 again. In that case, the first prompt in Step 2 is preferably modified from the above first prompt. The user can perform the modification.

### Step 5: Classification First Specification to Obtain First Chapter

In this step, the specification preparation support system classifies the first specification into appropriate ranges to obtain a given chapter. In this step, at least a first chapter is obtained as a given chapter. It is preferable that the first chapter be displayed on the specification division display column 203a illustrated in FIG. 2A so that the user can check the first chapter.

The first chapter can also be obtained by utilizing the language model. For example, the specification preparation support system can obtain chapters classified by the above embodiments by supplying a prompt including the content “please classify the first specification into embodiments” to the language model.

In the case where the language model is used, a prompt for additionally obtaining a summary corresponding to each chapter may be prepared. The prompt is supplied to the language model, so that the summary can also be obtained by the specification preparation support system. Typically, the summary can be displayed near the specification division display column 203a illustrated in FIG. 2A. The user can understand the embodiments in a short time by checking the summary, which is preferable. Note that a prompt obtained by replacing the embodiment of the prompt with an example can be prepared.

### Step 6: First Data Extraction

In this step, the specification preparation support system extracts data related to the first chapter from a database. Typically, data extraction is performed in the processing portion 130 or the like illustrated in FIG. 6. The database may be owned by the specification preparation support system, or may be owned by another data processing device (component) different from the specification preparation support system. The data is sometimes referred to as first data to be distinguished from the other data. Note that the method for extracting the first data is not limited to the method described here, for example.

With reference to a large amount of the first data, the specification preparation support system can propose a specification with an appropriate summary of the invention. In the case where the specification includes a large amount of the first data, the number of characters of the first chapter is preferably small. This is because the language model processing is performed within the limit of the number of tokens. In particular, in the case where the first chapter corresponds to the core of the invention in the specification, the amount of the first data is enormous in some cases. Alternatively, in some cases, the specification is preferably revised using an enormous amount of the first data. In such a case, the number of characters of the first chapter is preferably set to be smaller in the specification preparation support system. This is preferable because a larger amount of data from the database can be written in the first chapter.

On the other hand, in the case where the database includes a small amount of the first data, the first chapter may be classified so as to be long within the limit of the number of tokens of the language model. The specification can be regarded as one chapter without being classified. This is preferable because revising can be performed while a wider context of the specification is considered than that in the case where the specification is classified into chapters.

### Step 7: Generation of Second Prompt and Obtainment of Second Chapter

In this step, the specification preparation support system creates a prompt including a content of revising the first chapter in accordance with the first data to to create a second chapter. The prompt in this step is referred to as a second prompt to be distinguished from other prompts. Typically, the prompt is generated in the processing portion 130 illustrated in FIG. 6. It is further preferable that the prompt be automatically generated in the processing portion 130 as described above. Needless to say, the prompt can be created by the user without being automatically generated. As illustrated, this step in the case where the prompt is automatically generated includes the step of generating the second prompt to the step of obtaining the second chapter. In the case where the prompt is not automatically generated, a step including the reception of the second prompt and a step including the obtainment of the second chapter are performed instead of Step 7. Note that in the case where the first chapter is an example, the second chapter is also obtained as an example.

As the language model, it is possible to use the one described in the first prompt generation, and as described in the first prompt generation, an appropriate number of tokens in the specification preparation support system may be set. The specification preparation support system may generate a prompt that specifies the number of output tokens.

In order to utilize the database, the first data specialized for the company is extracted, and the second chapter that is revised based on the first data is obtained. That is, the specification preparation support system can obtain the second chapter that is revised based on the first data specialized for the company. In other words, the second chapter obtained in this step is revised in accordance with the technical data of the company that the user belongs to, and thus can include data with originality. There is a possibility that the data with originality can ensure novelty.

### Step 8: Display of First Chapter and Second Chapter

In this step, the specification preparation support system displays the first chapter and the second chapter. Typically, as illustrated in FIG. 2B, the first chapter is displayed on the pre-revision specification display column 203b, and the second chapter is displayed on the after-revision specification display column 204.

### Step 9: Selection of One of First Chapter and Second Chapter

In this step, the user compares the first chapter and the second chapter and selects the one appropriate for the specification in accordance with the summary of the invention. That is, the first chapter is suitable for the specification in some cases. The user may select the chapter while referring to the first data. In that case, the first data is also displayed.

Such a step (typically Step 6 to Step 9) for revising from the first chapter to the second chapter and a step (typically Step 10) for selecting an appropriate chapter for the specification are repeated as appropriate to obtain a chapter suitable for the specification.

### Step 10: Proposition of Specification

In this step, the specification preparation support system combines all the chapters suitable for the specification to prepare the specification. The specification is referred to as a second specification to be distinguished from the other specifications. Then, the specification preparation support system can propose the second specification to the user. Typically, the second specification is displayed on the specification column 205 to be proposed, as illustrated in FIG. 3A. With the specification preparation support system through such steps, a high-quality specification can be obtained.

### Operation Method Example 2 of Specification Preparation Support System

A method for preparing a specification and the like in the specification preparation support system is described. Although the method is not illustrated, the first data in Step 6 shown in FIG. 8 can be obtained using RAG. By using the RAG, Step 6 shown in FIG. 8 can be combined into Step 7; thus, processing can be performed in a short time.

### Step 1 to Step 5

Step 1 to Step 5 are executed in a manner similar to that in the example 1. Step 6 can be combined into Step 7 described next.

### Step 7: Generation of Second Prompt Using RAG and Obtainment of Second Chapter

In the operation method example 2, the specification preparation support system in this step creates a second prompt including a content of obtaining the first data by using RAG, revising the first chapter in accordance with the first data, and creating the second chapter. RAG is a method of executing a search related to a question sentence in the database before the language model generates an answer sentence, so that the accuracy of the answer sentence of the language model can be increased based on the search result.

The specification preparation support system can use a means for searching the database similar to that in the example 1. A means for determining whether or not the data is related to the first chapter can be similar to that in the example 1. The database can also be similar to that in the example 1. The database includes a variety of data. Thus, the user preferably selects the database. When the specification preparation support system is used after the database is selected, appropriate first data can be obtained in a short time.

As the database, a database owned by the company can be used. Thus, the first data specialized for the company is generated, and the second chapter that is revised based on the first data can be obtained. That is, the specification preparation support system can obtain the second chapter that is revised based on the first data specialized for the company. That is, the first data is obtained using RAG. Accordingly, the second chapter specialized for the company, which is difficult to obtain only by the language model, can be obtained.

In the operation method example 2, the specification preparation support system preferably uses the summary of the first chapter for the second prompt. For example, in the case where the summary has a structure of a transistor including an oxide semiconductor and silicon oxide, the second prompt can include a content of “creating the second chapter by revising the first chapter with reference to a recent knowledge of the transistor including an oxide semiconductor and silicon oxide”.

When the first data is appropriate in this step, RAG may be executed once; however, in the case where the first data is inappropriate or the first data is to be modified, the RAG can be executed twice or more. Since the specification includes a wide range of descriptions, the RAG is preferably executed after the specification is classified to prepare the first chapter, in which case appropriate first data can be obtained.

### Step 8 to Step 10

Step 8 to Step 10 are executed in a manner similar to that in the example 1. With the specification preparation support system that has performed such steps, a high-quality specification can be obtained.

### Operation Method Example 3 of Specification Preparation Support System

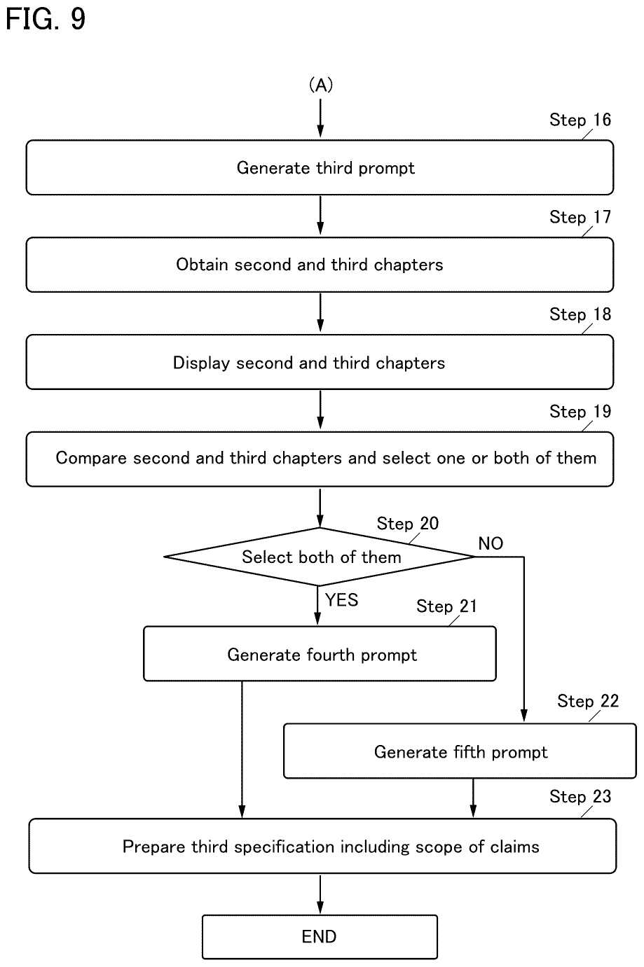

In the specification preparation support system, a method for creating a specification and a scope of claims is described. An example of this method includes Step 1 to Step 5 and Step 16 to Step 23 as illustrated in FIG. 7 and FIG. 9, respectively. Step 1 to Step 5 are described with reference to FIG. 7, and Step 16 to Step 23 are described with reference to FIG. 9. Note that (A) after Step 5 in FIG. 7 means that the operation continues to (A) shown in FIG. 9.

### <Step 1 to Step 5>

Step 1 to Step 5 are executed in a manner similar to that in the example 1. Step 6 can be combined into Step 16 described next.

### Step 16: Generation of Third Prompt Using RAG

In the operation method example 3, the specification preparation support system in this step creates a prompt different from the second prompt. In this step, the user creates the prompt without automatically generating the prompt. The prompt in this step is referred to as a third prompt to be distinguished from other prompts. Specifically, the third prompt includes a content of revising the first chapter to the second chapter in accordance with one piece of the first data and a content of creating a third chapter in accordance with another piece of the first data. Since the first data includes a wide range of data, the data related to the first chapter can be used for revision from the first chapter to the second chapter, and the data less relevant to the first chapter can be used for creating the third chapter. As in the case of the example 1 and the like, whether or not the first data is related to the first chapter can be determined by similarity of values based on the distributed representation. The first data can be divided in accordance with the similarity. In particular, in the case where experimental data is received in addition to the summary of the invention, a content of creating the second example corresponding to the second chapter and the third example corresponding to the third chapter can be included in the third prompt.

### Step 17: Obtainment of Second Chapter and Third Chapter

In this step, the specification preparation support system obtains the second chapter and the third chapter as answer sentences of the prompt from the language model. Note that in the case where the first chapter is an example, the second chapter and the third chapter are also obtained as examples.

The second chapter and the third chapter obtained in this step are revised in accordance with the technical data of the company that the user belongs to, and thus can include data with originality. There is a possibility that the data with originality can ensure novelty.

### Step 18: Display of Second Chapter and Third Chapter

In this step, the specification preparation support system displays the second chapter and the third chapter. Typically, using the after-revision specification display column 204 illustrated in FIG. 2B, the second chapter and the third chapter can be displayed.

### Step 19: Selection of One or Both of Second Chapter and Third Chapter

In this step, the user can compare the second chapter and the third chapter and select one or both of them. The user may select the chapter while referring to the first data. Typically, selection can be performed by using a selection button near the after-revision specification display column 204 in FIG. 2B.

Such a step (typically Step 16 to Step 18) for revising from the first chapter to the second chapter and a step (typically Step 19) for selecting an appropriate chapter for the specification are repeated as appropriate to obtain a chapter suitable for the specification.

### Step 20

In this step, the specification preparation support system determines whether or not both of the second chapter and the third chapter are selected by repeating Step 19 as appropriate. When both of the second chapter and the third chapter are selected more than once, the specification preparation support system proceeds to Step 21. When one of the second chapter and the third chapter is selected all the time, the specification preparation support system proceeds to Step 22.

### Step 21: Generation of Fourth Prompt

In this step, the specification preparation support system generates a prompt including a content of describing a matter specifying the invention included in the second chapter as an independent claim and a content of describing a matter specifying the invention included in the third chapter as a dependent claim. Furthermore, the prompt preferably includes a number candidate for the reference number of the independent claim.

### Step 22: Generation of Fifth Prompt

In this step, the specification preparation support system generates a prompt including a content of describing the matter specifying the invention included in the second chapter as an independent claim.

### Step 23: Obtainment of Third Specification Including Scope of Claims

In this step, the specification preparation support system obtains the specification and the scope of claims from the language model as answer sentences of the prompt. The specification is referred to as a third specification to be distinguished from other specifications. Typically, the specification is displayed on the specification column 205 to be proposed as illustrated in FIG. 3B, and the scope of claims is displayed on the column of the scope of claims 206 to be proposed. With the specification preparation support system through such steps, high-quality specification and scope of claims can be obtained. In particular, in the case where experimental data is received in addition to the summary of the invention, a matter specifying the invention included in the second example corresponding to the second chapter is preferably proposed as an independent claim. Furthermore, a matter specifying the invention included in the third example corresponding to the third chapter is preferably proposed as a dependent claim. In that case, proposition is preferably performed so as to cite the above-described independent claim.

This application is based on Japanese Patent Application Serial No. 2024-112566 filed with Japan Patent Office on Jul. 12, 2024, the entire contents of which are hereby incorporated by reference.

What is claimed is:

1. A system comprising a first component,
wherein the first component is configured to:
receive a summary of an invention,
generate a first prompt for obtaining a first specification corresponding to the summary of the invention,
obtain the first specification from a language model as an answer to the first prompt,
display the first specification on an information terminal of a user,
classify the first specification into chapters,
generate a second prompt for obtaining data related to a classified first chapter from a second component and creating a second chapter by revising the first chapter in accordance with the data,
obtain the second chapter as an answer to the second prompt from the language model,
display the first chapter and the second chapter on the information terminal of the user,
compare the first chapter and the second chapter to select the chapter which is suitable for the summary of the invention, and
prepare a second specification comprising the selected chapter.

2. A system comprising a first component,
wherein the first component is configured to:
receive a summary of an invention,
generate a first prompt for obtaining a first specification corresponding to the summary of the invention,
obtain the first specification from a language model as an answer to the first prompt,
display the first specification on an information terminal of a user,
classify the first specification into chapters,
generate a second prompt for obtaining a plurality of pieces of information related to a classified first chapter from a second component, creating a second chapter by revising the first chapter in accordance with the plurality of pieces of information, and creating a third chapter in addition to the second chapter in accordance with the plurality of pieces of information,
obtain the plurality of pieces of information, the second chapter, and the third chapter as an answer to the second prompt from the language model,
display the plurality of pieces of information, the second chapter, and the third chapter on the information terminal of the user,
compare the second chapter and the third chapter to select the chapter or the chapters suitable for the summary of the invention, and
prepare a second specification comprising the selected chapter or the selected chapters.

3. The system according to claim 2,
wherein in the case where the second chapter and the third chapter are deemed suitable for the summary of the invention:
the first component is configured to generate a third prompt for obtaining a content describing a matter specifying an invention included in the second chapter as an independent claim of a third specification and a content describing a matter specifying an invention included in the third chapter as a dependent claim of the independent claim and describing the dependent claim while citing the independent claim, and
the first component is configured to obtain the third specification from the language model as an answer to the third prompt.

4. A system comprising a first component,
wherein the first component is configured to:
receive a summary of an invention and first experimental data,
generate a first prompt for obtaining a first specification corresponding to the summary of the invention and describing the first experimental data in a first example of the first specification,
obtain the first specification from a language model as an answer to the first prompt,
display the first specification on an information terminal of a user,
classify the first specification into chapters,
generate a second prompt for obtaining information related to the first example from a second component and creating a second example by revising the first example in accordance with the first experimental data,
obtain the second example as an answer to the second prompt from the language model,
display the first example and the second example on the information terminal of the user,
compare the first example and the second example to select the example suitable for the summary of the invention, and
prepare a second specification comprising the selected example.

5. The system according to claim 1,
wherein the summary of the invention comprises a description of an object and a description of an effect.

6. The system according to claim 2,
wherein the summary of the invention comprises a description of an object and a description of an effect.

7. The system according to claim 4,
wherein the summary of the invention comprises a description of an object and a description of an effect.
